(19) United States
(12) Patent Application Publication
(10) Pub. No.: US 2005/0213574 A1
(43) Pub. Date: Sep. 29, 2005

(54) Communication system

(76) Inventors: Naomasa Yoshimura, Kawasaki (JP); Kenichi Abe, Kawasaki (JP); Katsuhito Asano, Kawasaki (JP); Takamitsu Shirai, Kawasaki (JP)

Correspondence Address: KATTEN MUCHIN ROSENMAN LLP, 575 MADISON AVENUE, NEW YORK, NY, 10022-2585, US

(21) Appl. No.: 10/965,094

(22) Filed: Oct. 14, 2004

(30) Foreign Application Priority Data
Mar. 23, 2004 (JP) 2004-083982

(51) Int. Cl. H04L 12/56

(52) U.S. Cl. 370/389

(57) ABSTRACT

A communication system capable of high-quality routing and improved in operability. An IPsec tunneling control section sets up an IPsec tunnel on the Internet between the device in which it is provided and a remote router, by using an ISAKMP default route. A routing registration section has a routing table in which local IP addresses as destination addresses are statically registered and also a second router is statically registered as an IP default route for addresses other than the registered local IP addresses. When the IPsec tunnel is set up, the routing registration section identifies a global IP address of the remote router and dynamically registers the global IP address in the routing table in association with the corresponding local IP address. A packet transfer section transfers packets in accordance with the routing table.

### CROSS-REFERENCE TO RELATED APPLICATIONS

This application is based upon and claims priority of Japanese Patent Application No. 2004-083982, filed on Mar. 23, 2004, the contents being incorporated herein by reference.

### BACKGROUND OF THE INVENTION

(1) Field of the Invention

The present invention relates to a communication system, and more particularly, to a communication system for routing packets for communication thereof.

(2) Description of the Related Art

Information communication networks of various forms are currently configured, and with increase in transmission capacity, improvement of communication quality and serviceability is hoped for. In the circumstances, network communications are exposed to various menaces such as wiretapping and alteration, and more and more growing importance is placed on security functions.

There are a variety of security functions currently in use. Specifically, protocols for security purposes have been prepared for individual applications, for example, PGP (Pretty Good Privacy) for the protection of mail communication and SSL (Secure Sockets Layer) for the protection of WWW communication.

In recent years, security technology called IPsec (IP Security Architecture) is attracting attention. IPsec offers confidentiality of IP packets themselves and access control is performed while guaranteeing packet information, thereby ensuring security on an IP packet basis and not for a specific application. It is therefore possible to protect diverse applications without the need to prepare security functions for the individual applications.

IPsec is also used as a method of realizing a VPN (Virtual Private Network). A VPN is a virtual private communication network configured to interconnect different places and allows users to use public lines just like leased lines through a network configured within a company.

VPNs are generally divided into IP-VPN and Internet VPN. The VPN configured using a carrier-constructed private IP network as a backbone is called IP-VPN, and the VPN realized on the Internet is called Internet VPN.

The Internet VPN uses the Internet as the backbone and is therefore advantageous over the IP-VPN in that the cost of maintaining lines is very low and thus that the operation cost is also low. However, data, if directly transferred over the Internet, is vulnerable to wiretapping, alteration, etc. Thus, in order to perform secure communication on the insecure Internet, the Internet VPN uses IPsec for encrypting the contents of communicated data, to permit communication of highly confidential data.

There has also been proposed a conventional technique wherein when a port is reserved for the IPsec protocol, a gateway located between a LAN and the Internet suspends ordinary network address translation and encrypts data communicated between the LAN and the Internet by using the IPsec protocol (e.g., Japanese Unexamined Patent Publication No. 2001-313679 (pages 7 and 8, FIG. 1)).

The Internet VPN explained above is expected to be widely used in the future mainly by corporate users as a form of communication that permits low-cost operation while at the same time ensures security.

Meanwhile, to permit Web access from an intranet (local network) to the Internet in the Internet VPN environment, a dedicated gateway server (having a firewall mechanism) for connecting with the Internet needs to be provided so that communication with the Internet may be performed via the gateway server.

Consequently, the network as a whole must be configured such that the intranets at remote places are interconnected by using inexpensive Internet connection service to communicate IPsec-encrypted data therebetween while the connection with the Internet from the intranets is permitted only via the gateway server, thus requiring an environment having two routes for the Internet connection.

In cases where non-fixed IP addresses which vary each time connection is established, instead of fixed IP addresses, are used in Internet connection services, a center router located at the boundary between Internet and intranet paths generally performs routing by default routing control. In the network environment configured as described above, however, since it is impossible to set default routes enabling normal routing, destination IP addresses cannot be set, giving rise to a problem that routing cannot be performed.

Conventionally, to solve the problem, routing is carried out using policy routing (routing method in which routing is decided on the basis of the user's policy or the provider's service provision policy). However, since complicated settings are required to carry out policy routing, heavy burden is imposed on the network administrator. Also, because of its low efficiency, policy routing cannot be said high-convenience, high-operability techniques.

The conventional technique (Japanese Unexamined Patent Publication No. 2001-313679) also takes no account of the aforementioned network configuration and does not offer a solution to the problem.

### SUMMARY OF THE INVENTION

The present invention was created in view of the above circumstances, and an object thereof is to provide a communication system capable of realizing high-quality routing in a network environment in which intranets are interconnected through an IPsec tunnel set up on the Internet and communication with the Internet is permitted only via a gateway server.

To achieve the object, there is provided a communication system for communicating packets. The communication system comprises a first router connected to the Internet, a second router connected to an intranet, a remote router located at a boundary between the Internet and a local network, the remote router being assigned a non-fixed IP address when connecting to the Internet for communication therewith, and a center router connected to the first and second routers and located at a boundary between the Internet and the intranet, the center router including an IPsec tunneling control section for setting up an IPsec tunnel on the Internet between the center router and the remote router by using an ISAKMP default route indicative of routing to the first router, a routing registration section having a routing table in which local IP addresses as destination addresses are statically registered and in which the second router is statically registered as an IP default route for addresses other than the registered local IP addresses, the routing registration section identifying a global IP address of the remote router and dynamically registering the global IP address in the routing table in association with the corresponding local IP address when the IPsec tunnel is set up, and a packet transfer section for transferring packets in accordance with the routing table.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principle of a communication system according to the present invention.

FIG. 2 is a diagram showing an Internet VPN configuration.

FIG. 3 is a diagram exemplifying communication through an IPsec tunnel.

FIG. 4 is a diagram showing a network environment in which a gateway is installed and an IPsec tunnel is not set up.

FIG. 5 is a diagram showing a network environment in which a gateway is installed and an IPsec tunnel is set up.

FIG. 6 is a diagram illustrating the forwarding of a reply packet.

FIG. 7 is a diagram showing a routing table.

FIG. 8 is a diagram illustrating the establishment of an IPsec tunnel.

FIG. 9 is a diagram showing the routing table.

FIG. 10 is a diagram illustrating how Internet VPN communication is performed.

FIG. 11 is a diagram illustrating how Internet access communication is performed.

### DESCRIPTION OF THE PREFERRED EMBODIMENTS

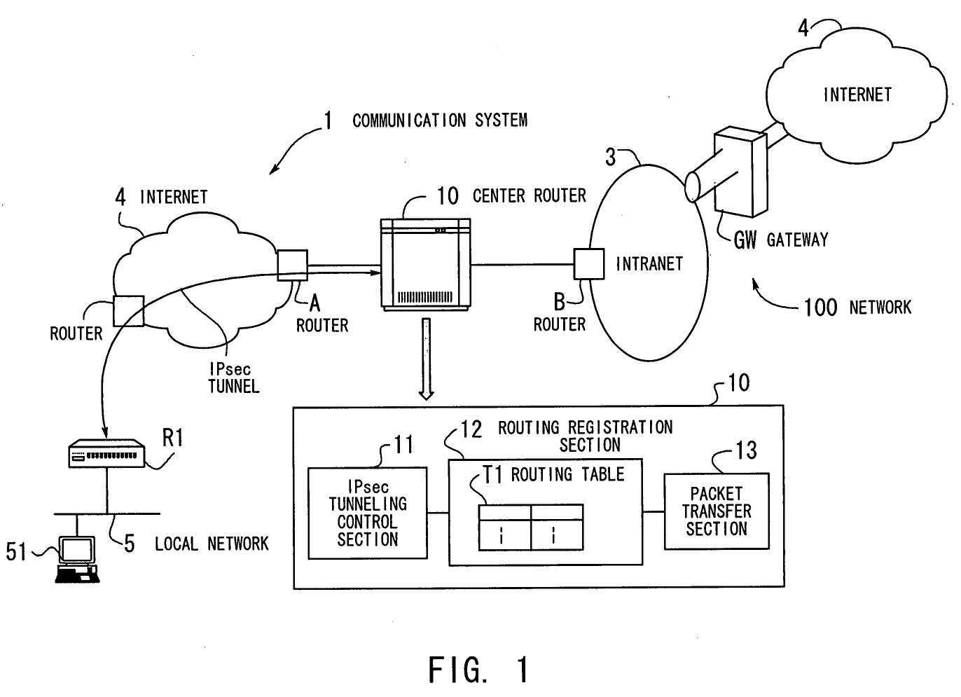

Embodiments of the present invention will be hereinafter described with reference to the drawings. FIG. 1 illustrates the principle of a communication system according to the present invention. The communication system 1 of the present invention includes a first router (hereinafter router A), a second router (hereinafter router B), a remote router R1, and a center router 10.

A network 100 to which the system of the present invention is applied has an environment in which the center router 10 is connected to the routers A and B and located at the boundary between the Internet 4 and an intranet 3, the routers A and B being connected to the Internet 4 and the intranet 3, respectively.

A gateway GW is connected to the intranet 3 and the Internet 4. The gateway GW is a device having a firewall mechanism and adapted to perform network address translation (address translation between global and local IP addresses). The remote router R1 is connected to a local network 5 and located at the boundary between the Internet 4 and the local network 5 (The intranet 3 and the local network 5 are named differently, but since both are private networks, the local network may be regarded as an intranet). A terminal 51 is connected under the remote router R1.

In the illustrated environment, the center router 10 and the remote router R1 perform communication control in accordance with ISAKMP (Internet Security Association and Key Management Protocol) to set up an IPsec tunnel (The remote router R1 is assigned a non-fixed IP address when connecting to the Internet 4 for communication therewith).

According to the present invention, the terminal 51 within the local network 5 can communicate with the intranet 3 by means of an Internet VPN configured through the IPsec tunnel, and can further communicate with the Internet 4 via the gateway GW (ISAKMP and IPsec tunnel will be outlined later).

The center router (router device of the present invention) 10 comprises an IPsec tunneling control section 11, a routing registration section 12, and a packet transfer section 13. The IPsec tunneling control section 11 sets up an IPsec tunnel on the Internet 4 between the center router 10 and the remote router R1 by using an ISAKMP default route indicative of routing to the router A.

The routing registration section 12 has a routing table T1 in which routing information is registered. In the routing table T1 are statically registered local IP addresses as destination addresses, as well as the router B as an IP default route for packets with addresses other than the registered local IP addresses. Further, when the IPsec tunnel is set up, a global IP address of the remote router R1 is identified and also the global IP address and the router A as a forwarding route are dynamically registered in the routing table T1 in association with the corresponding local IP address.

Static registration means that routing information (destination addresses) is set beforehand in the table by the network administrator, and routing based on the routing information registered in this manner is called static routing. On the other hand, dynamic registration means that routing information is automatically set in the table by the router, and routing based on the routing information registered in this manner is called dynamic routing.

In accordance with the contents registered in the routing table T1, the packet transfer section 13 transfers packets. Before the IPsec tunnel is set up, a sending packet is discarded as a packet with an uncertain destination if the destination address thereof coincides with any of the registered local IP addresses.

Also, before the IPsec tunnel is set up, a sending packet is transferred to the router B, which is the IP default route, if the destination address thereof does not coincide with any of the registered local IP addresses.

After the IPsec tunnel is set up, a sending packet is transferred to the router B, which is the default route, if its destination address after decapsulation does not coincide with any of the registered addresses.

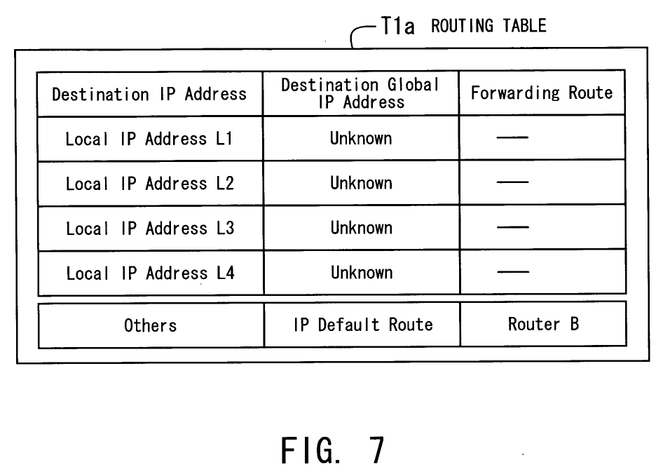

Also, after the IPsec tunnel is set up, a sending packet, if the destination address thereof coincides with any of the registered local IP addresses, is encapsulated in the global IP address associated with the corresponding local IP address (the global IP address dynamically registered by the routing registration section 12) and then is transferred to the router A. The communication performed according to the present invention will be described in detail later with reference to FIG. 7 and the following figures.

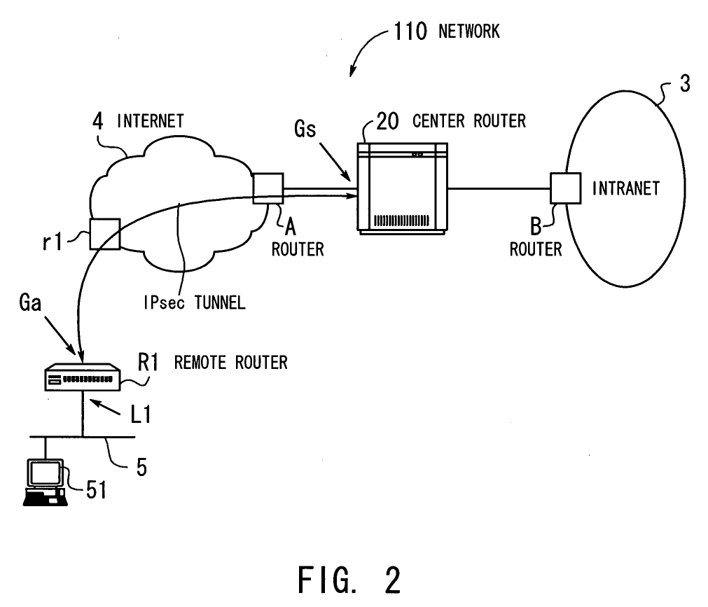

Referring now to FIGS. 2 to 6, IPsec communication will be outlined and also problems to be solved by the present invention will be explained in detail. FIG. 2 shows the configuration of an Internet VPN. In a network 110, a center router 20 is connected to a router A, which in turn is connected to the Internet 4, and is also connected to a router B, which in turn is connected to an intranet 3. A terminal 51 is connected under a remote router R1. The remote router R1 and the center router 20 each support the IPsec communication function.

To carry out routing, the center router 20 has a routing table showing the correspondence between destination addresses and next hops. Specifically, local IP addresses within the intranet 3 and local IP addresses within a local network 5 to which the remote router R1 is connected are registered beforehand in the routing table by the administrator.

When performing VPN communication between the remote router R1 and the intranet 3, the remote router R1 first acquires a non-fixed IP address and then connects with the Internet 4 via a router r1 belonging to the Internet 4, to establish IPsec encrypted communication and thereby configure an Internet VPN.

At this time, a secure tunnel (IPsec tunnel) called SA (Security Association) is established between the remote router R1 and the center router 20. SA is configured on a traffic-by-traffic basis (since SA is configured independently for one-way communication, two SA's are needed to perform two-way communication) and is updated periodically (for the purpose of improving security through the confirmation of identities by re-authentication and the updating of encryption keys).

A protocol for the automatic establishment and management (inclusive of key management) of SA is standardized as IKE (Internet Key Exchange), and the packet format used in IKE is set by the protocol called ISAKMP.

Generally, in IPsec communication, when a remote client accesses the Internet, tunnel mode is used wherein the header and payload of an IP packet are in their entirety encrypted (encapsulated) and the encrypted information is carried as a payload. Thus, by setting up an IPsec tunnel which is a secure communication path for exchanging encrypted IP packets on the Internet, secure communication can be performed even via the Internet.

The following is an outline of the procedure which is followed to enable IPsec tunnel communication on the network 110 shown in FIG. 2. The center router 20 has a global IP address which is fixedly assigned thereto (set beforehand) on the Internet 4, and the remote router R1 has a global IP address (non-fixed IP address) which is assigned each time the remote router R1 connects with the center router 20 (namely, each time the remote router R1 connects with the center router 20, it is assigned a global IP address from the ISP (Internet Service Provider)). In the figure, Gs denotes a fixed global IP address assigned to the center router 20, and Ga denotes a non-fixed IP address assigned to the remote router R1.

Addresses are defined as follows: A global IP address is a sole IP address on the Internet uniquely assigned by the ISP, and a local IP address is an IP address which is assigned inside a private network and cannot be used for the connection with the Internet (In short, addresses used on the Internet are global IP addresses and addresses used on an intranet or local network are local IP addresses). A non-fixed IP address denotes a global IP address which is assigned by the ISP and which varies each time connection with the Internet is established.

The center router 20 has the local IP address (hereinafter L1) of the remote router R1 registered therein beforehand, but does not have routing information about the remote router on the Internet 4 (namely, at this stage, the center router does not know the global IP address assigned to the remote router R1).

Ordinary routers have the function of notifying each other of the connection status of their subordinate devices, as part of inter-router protocol. The routers A and B and the center router 20 are, however, made not to exercise this function because, with such function, the network can be seen from outside, possibly causing a security problem (especially, the router A and the center router 20 are caused not to exchange connection status information with each other).

Basically, therefore, routers located near the boundary between the Internet and the intranet are registered in advance with information about the destinations of all routings (after the IPsec tunnel is set up, however, the center router 20 can identify the global IP address Ga of the remote router R1).

Thus, when a packet with a global IP address (destined for the Internet) is received before the establishment of an IPsec tunnel, the center router 20 is unable to determine, by the global IP address of the received packet, where to forward the packet even if the received packet is a packet for establishing an IPsec tunnel (packet for establishing an IPsec tunnel is hereinafter referred to as Pt). Such packets with addresses which are not registered in the routing table are forwarded to a default route.

In the process of setting up the IPsec tunnel with the remote router R1, a route from the center router 20 to the router A is set as the default route (ISAKMP default route) so that all packets Pt with global IP addresses may be forwarded to the router A which is the ISAKMP default router.

The router A can identify the global IP address assigned to the remote router R1. On receiving the packet Pt, therefore, the router A forwards the packet Pt to the remote router R1 through the router r1. In this manner, the remote router R1 and the center router 20 can communicate with each other and the IPsec tunnel is set up between the center router 20 and the remote router R1, whereby IPsec encrypted communication can be performed across the Internet 4.

The IKE key exchange protocol has Main mode and Aggressive mode as operation modes. During the establishment of the IPsec tunnel, the Aggressive mode is used in which the IP address of the remote router may be either fixed or non-fixed (the Main mode can be used only when the IP address is a fixed IP address).

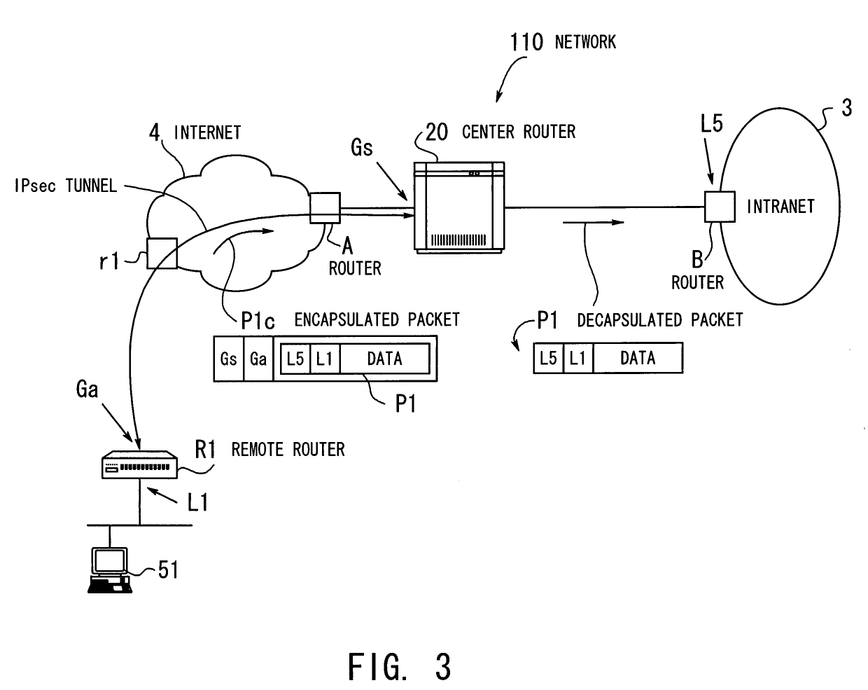

FIG. 3 illustrates exemplary communication using an IPsec tunnel. As shown in the figure, the local IP address of the intranet 3 is L5, and when the remote router R1 communicates with the intranet 3 by using the IPsec tunnel (Internet VPN), the remote router transmits an encapsulated packet P1c to the center router 20.

The packet P1c generally has the following format: An IP packet P1, which includes the destination address L5 and the source address L1 in the header thereof and IPsec tunneling information in the payload thereof, is encapsulated with the destination address Gs and the source address Ga affixed thereto.

On receiving the packet P1c, the center router 20 decapsulates the packet P1c and identifies the destination L5. Since the center router 20 already has information on the local IP addresses in the intranet 3, the decapsulated packet P1 is forwarded to the intranet 3.

Let us now consider the case where the remote router R1 performs Web access to the Internet 4 in the environment of the network 110 shown in FIG. 2. When performing Web access to the Internet 4, the remote router R1 should not directly access the Internet 4 just for the reason that it already has a global IP address, since security is not ensured for such connection.

Accordingly, to ensure secure Web access from the remote router R1 (from the terminal 51 under the remote router R1) to the Internet 4, the network needs to be configured such that a firewall, which is a defensive barrier for preventing unauthorized access to an intranet from the Internet, exists between the local intranet within an organization and the outside Internet to allow connection with the Internet to be established via the firewall.

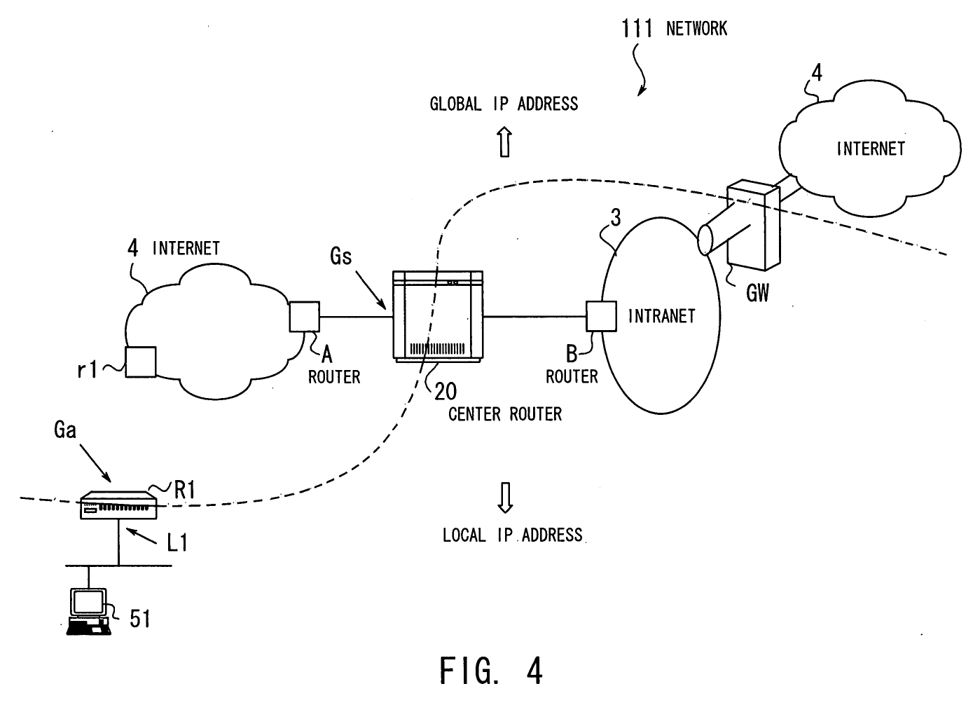

FIG. 4 shows a network environment in which a gateway is installed and an IPsec tunnel is not set up. In the configuration of the network 111, a gateway GW is provided for the network 110 of FIG. 2 in which the IPsec tunnel is not set up.

As shown in the figure, to enable access to the Internet, the gateway GW having a firewall mechanism is arranged between the intranet 3 and the Internet 4 (in the figure, the Internet 4. is indicated by two network clouds which, in actuality, are the same). Also, in the figure, the part above the dashed line indicates a domain where global IP addresses are used (Internet environment) and the part below the dashed line indicates a domain where local IP addresses are used (intranet environment).

To carry out Internet access communication in the network 111 configured in this manner, an IPsec tunnel needs to be set up first. With the IPsec tunnel establishment control explained above with reference to FIG. 2, however, the IPsec tunnel may possibly fail to be set up in the network 111.

The reason will be explained. The center router 20 does not have information about routing on the Internet 4, as mentioned above. Accordingly, for the center router 20, packets with global IP addresses (destined for the Internet 4) are packets with addresses which are not registered in the table, and thus, are forwarded to the default route. In this instance, since Internet access communication is to be performed, the center router 20 sets the router B as the default router.

In this case, even if the packet Pt for setting up an IPsec tunnel is transmitted from the remote router R1 to the center router 20, the center router 20 forwards the packet Pt to the router B, and not to the router A.

Namely, regardless of whether the packet is for the establishment of an IPsec tunnel or for the Internet access, the packet has a global IP address destined for the Internet 4. Thus, on receiving such packets, the center router 20 forwards all the packets to the currently set default router B. A problem therefore arises in that the IPsec tunnel fails to be set up (Conventional routers can have two default routes in the sense of duplexing but have only one default route in the original sense that the default route indicates a forwarding route for packets with destination addresses not registered in the routing table).

Even if an IPsec tunnel could be set up in the Aggressive mode in the environment of the network 111, Internet access communication cannot be performed normally, for the reason stated below.

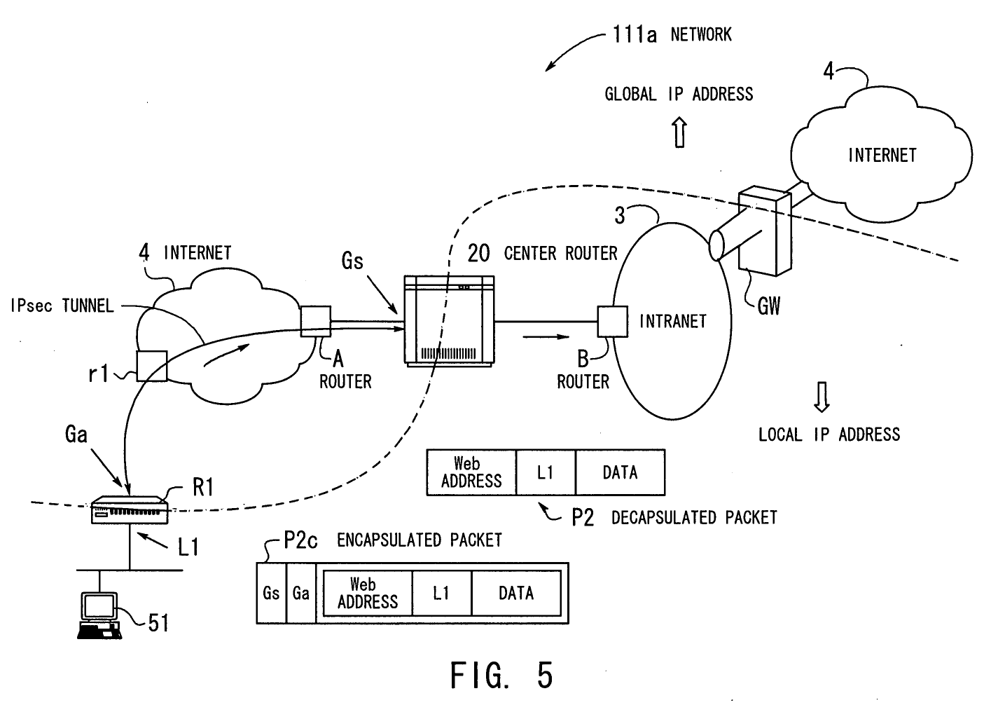

FIG. 5 shows a network environment in which a gateway is installed and also an IPsec tunnel is set up. In the environment of the network 111a, communication from the terminal 51 under the remote router R1 to the center router 20 is performed through the IPsec tunnel and thus security is ensured (communication through the IPsec tunnel is free of intrusion from the outside Internet 4 and also packets are prevented from flowing to the outside of the tunnel).

The communication from the center router 20 to the intranet 3 is performed through a private network and is free of intrusion from outside. Also, the communication from the intranet 3 to the Internet 4 is carried out through the gateway GW, and therefore, security is ensured.

Let us consider the case where a packet is transmitted from the remote router R1 to the Internet 4 at the time of Internet access. The remote router R1 sends an encapsulated packet P2c to the center router 20 through the IPsec tunnel. The center router 20 decapsulates the packet P2c and, on identifying a Web address set as the destination, forwards the decapsulated packet P2 along the default route to the router B. The router B forwards the packet P2 to the gateway GW, and the packet P2 is output to the Internet 4 through the gateway GW.

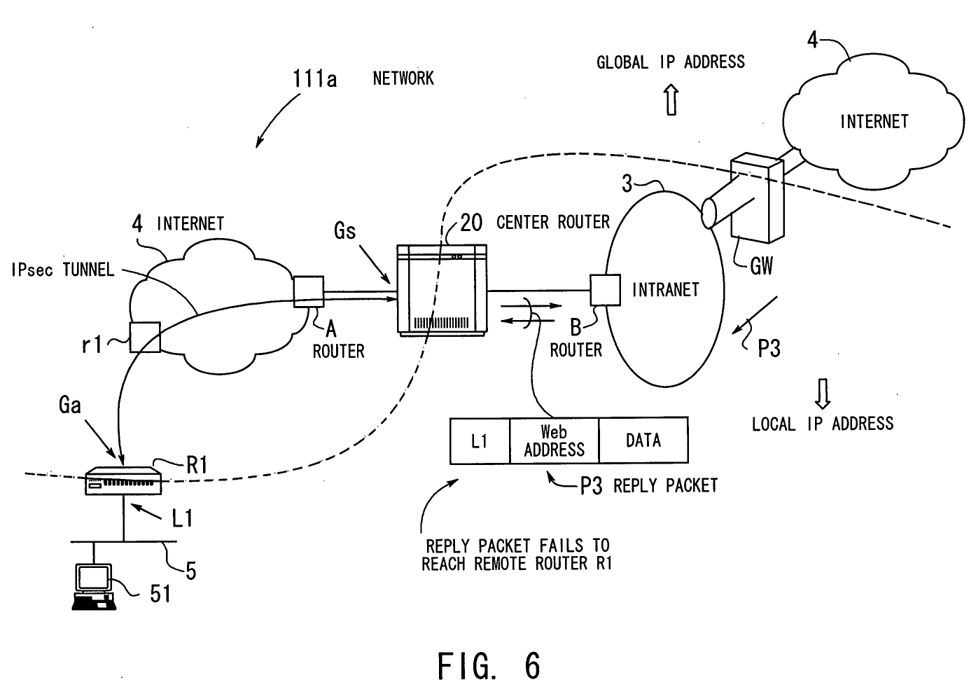

Now let us consider the case where a reply packet is sent from the Internet 4 to the remote router R1. FIG. 6 illustrates the forwarding of a reply packet. On receiving a packet from the Internet 4, the gateway GW performs address translation and generates a reply packet P3. It is assumed here that the reply packet P3 can reach the center router 20 via the router B.

The center router 20 receives the packet P3 and performs routing therefor, but since the packet P3 includes the local IP address L1 as its destination, that is, a global IP address destined for the Internet 4, the center router 20 forwards the packet not to the router A, but to the router B along the current default route.

The IPsec tunnel between the center router 20 and the remote router R1 has already been set up, and accordingly, the center router can identify the global IP address Ga assigned to the remote router R1. Since this global IP address is not registered in the routing table, however, routing is carried out based on the original routing information statically registered in the table. As a result, when the packet P3 destined for the local IP address L1 is received, the center router cannot forward the packet to the router A but transfers the packet to the default router B instead.

Thus, a problem arises in that although a packet can be transmitted from the remote router R1 to the Internet 4, a reply packet fails to reach the remote router R1.

As stated above, even if an attempt is made to set up an IPsec tunnel for Internet access communication in the environment like that of the network 111 shown in FIG. 4, the IPsec tunnel may possibly fail to be set up, and if the tunnel could be set up, a reply packet fails to reach the destination.

Conventionally, therefore, routing is carried out by using techniques called policy routing whereby packets are transferred to specific interfaces on the basis of the policies set by the user, in disregard of the routing information registered in the routing table.

However, policy routing is a static routing process which on one hand allows more detailed specification of routing objects but on the other hand requires extremely complicated settings. Thus, a heavy burden is imposed on the network administrator, and also because of its low efficiency, policy routing cannot be said high-convenience, high-operability techniques.

The present invention provides a communication system, a router device and a routing method which are capable of realizing high-quality routing, without the need to perform conventional complex policy routing, in a network environment in which the connection between intranets (intranet and local network) is established on the Internet by making use of IPsec and the communication with the Internet is permitted only via a gateway server.

Operation according to the present invention will be now described in detail. FIG. 7 shows a routing table. The routing table T1, which is managed by the routing registration section 12, is constituted by three items, namely, destination IP address, destination global IP address, and forwarding route. The figure shows a state of the routing table T1a after static registration.

Local IP addresses as destination addresses are registered beforehand. Also, for addresses (in the figure, “Others”) other than the registered local IP addresses, the router B is registered beforehand as the default route. After the IPsec tunnel is set up, the packet transfer section 13 transfers packets in accordance with the contents registered in the routing table. In this case, if a sending packet has a destination address (either local IP address or global IP address) other than the local IP addresses L1 to L4 registered in the table, that is, if the destination address of a sending packet is not registered in the table, the packet is regarded as falling under “Others” and thus is forwarded to the router B as the IP default route.

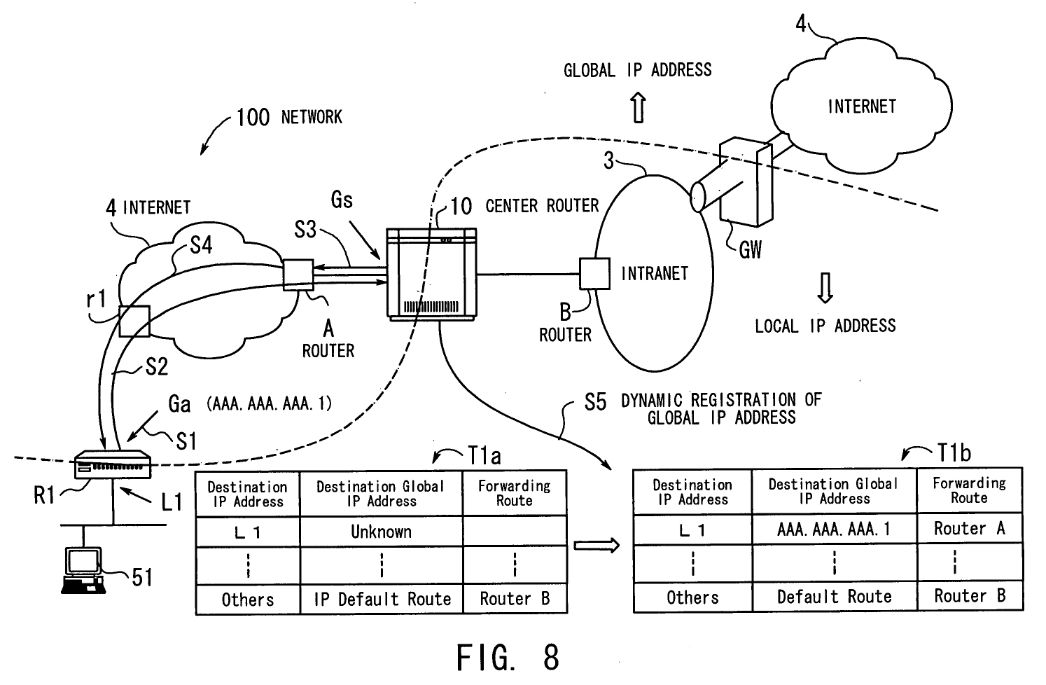

The following describes the operation performed from the establishment of an IPsec tunnel to the dynamic registration of the routing table T1 in the environment of the network 100 shown in FIG. 1. FIG. 8 illustrates the establishment of an IPsec tunnel. It is assumed that the routing information shown in FIG. 7 is already registered in the routing table.

[S1] When connecting to the Internet 4, the remote router R1 is assigned a global IP address Ga from the ISP.

[S2] The remote router R1 generates a packet for setting up an IPsec tunnel and sends the packet to the center router 10.

[S3] The center router 10 receives the packet. Subsequently, the IPsec tunneling control section 11 generates a packet for setting up an IPsec tunnel and sends the packet to the router A by using the ISAKMP default route (When an IPsec tunnel is to be set up, the IPsec tunneling control section 11 recognizes that the router A is the default route (ISAKMP default route), and sends a packet containing information necessary for the establishment of the tunnel to the ISAKMP default router A, without searching the routing table).

[S4] The router A knows the global IP address Ga of the remote router R1 and thus forwards the received packet to the remote router R1. As a result of Steps S1 to S4, an IPsec tunnel is set up (The procedure for setting up a tunnel in accordance with the IPsec tunneling protocol is not the subject of the present invention, and therefore, detailed description thereof is omitted. For details, refer to IETF 1825, 1826, 1827, 1829 and RFC 2409, etc. in which the standardization of IPsec and IKE is described).

[S5] When the IPsec tunnel is set up, the routing registration section 12 identifies the global IP address of the remote router R1 as well as the router A as a forwarding route, and dynamically registers, in the routing table T1a, the global IP address and the router A in association with the corresponding local IP address, thereby updating the routing table T1b.

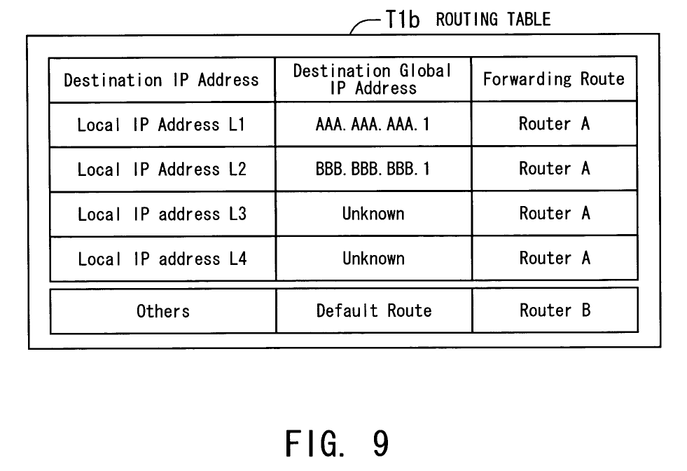

FIG. 9 illustrates the routing table. The routing table T1b shows a state after the global IP address and the router A are dynamically registered in the table shown in FIG. 7. The routing registration section 12 identifies the global IP address Ga of the remote router R1 when the IPsec tunnel is set up, and registers Ga (in the figure, “AAA.AAA.AAA.1”) in the column “Destination Global IP Address” and the router A in the column “Forwarding Route” in association with the corresponding local IP address L1 in the routing table T1.

In the figure, a global IP address “BBB.BBB.BBB.1” corresponding to the local IP address L2 is also registered on the assumption that an IPsec tunnel has been set up also with respect to the local IP address L2. When the IPsec tunnel shuts down, the global IP address registered in association with the corresponding local IP address is deleted.

In conventional systems, all routing information is statically registered in the routing table of the router device which is located at the boundary between the Internet 4 and the intranet 3, like the center router 20, in order to ensure security. According to the present invention, by contrast, when the IPsec tunnel is set up, the identified global IP address is automatically (dynamically) registered by the routing registration section 12 (Since the IPsec tunnel has been set up, such dynamic registration causes no security problem).

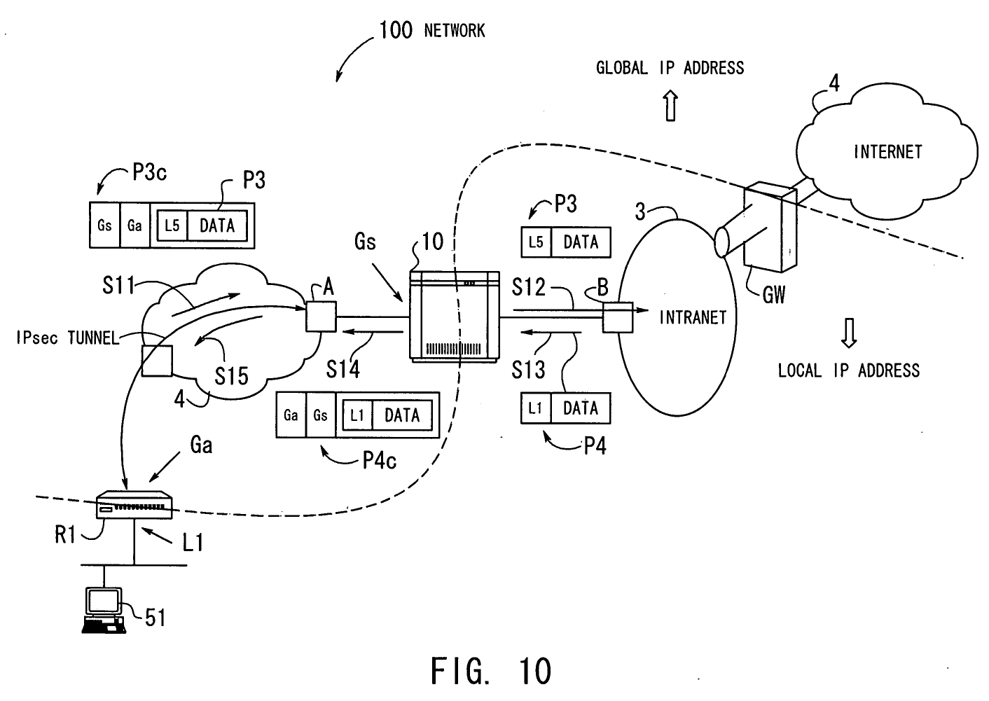

Internet VPN communication according to the present invention will be now described. FIG. 10 illustrates the Internet VPN communication.

[S11] In this instance, the Internet VPN communication is performed between the terminal 51 under the remote router R1 and a terminal within the intranet 3 (communication is performed between the remote router R1 and the intranet 3). The remote router R1 generates a packet P3c by encapsulating a packet P3 having a destination address L5 (only the destination address is shown in the header), and transmits the packet to the center router 10 through the IPsec tunnel.

[S12] The center router 10 receives the packet P3c and decapsulates same. The destination address of the packet P3 is the local IP address L5. Since L5 is not registered in the routing table T1b, the packet is forwarded to the router B as the IP default route. Thus, the packet P3 is sent to the intranet 3 and received thereafter by the corresponding terminal.

[S13] A reply packet P4 is sent from the intranet 3 to the center router 10, and the center router 10 receives the packet P4.

[S14] Since the destination address of the reply packet P4 is the local IP address L1, the center router 10 judges from the routing table T1b that the corresponding global IP address is “AAA.AAA.AAA.1” and that the forwarding route is the router A. Accordingly, the center router generates a packet P4c by encapsulating the packet P4 in the global IP address “AAA.AAA.AAA.1” and forwards the generated packet to the router A.

[S15] The router A sends the packet P4c to the remote router R1, which then decapsulates the packet P4c.

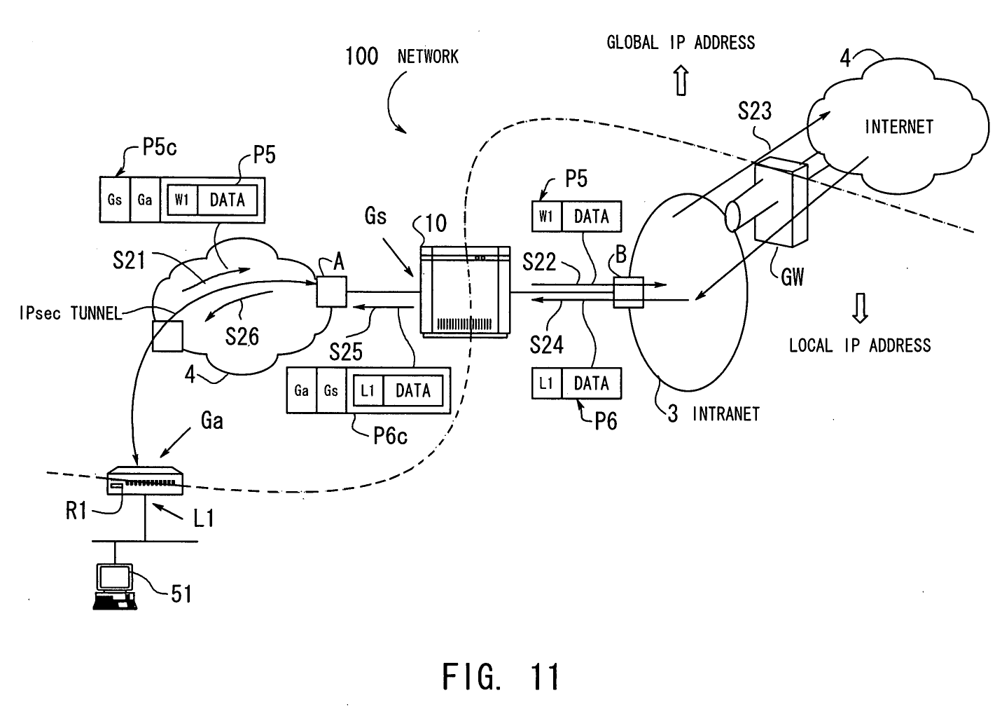

Internet access communication according to the present invention will be now described. FIG. 11 illustrates the Internet access communication.

[S21] In this instance, the terminal 51 under the remote router R1 communicates with the Internet 4 via the gateway GW (communication is performed between the remote router R1 and the Internet 4). The remote router R1 generates a packet P5c by encapsulating a packet P5 having a Web address (in the FIG. W1) as its destination address (only the destination address is shown in the header), and sends the generated packet to the center router 10 through the IPsec tunnel.

[S22] The center router 10 receives the packet P5c and decapsulates same. The destination address of the packet P5 is the global IP address W1. Since W1 is not registered in the routing table T1b, the packet is forwarded to the router B as the IP default route.

[S23] The packet P5 is transmitted to the Internet 4 along the route: router B→intranet 3→gateway GW→Internet 4.

[S24] A reply packet P6 is transmitted from the Internet 4 to the center router 10 along the route: gateway GW→intranet 3→router B→center router 10. Thus, the center router 10 receives the packet P6.

[S25] Since the destination address of the reply packet P6 is the local IP address L1, the center router 10 judges from the routing table T1b that the corresponding global IP address is “AAA.AAA.AAA.1” and that the forwarding route is the router A. Accordingly, the center router generates a packet P6c by encapsulating the packet P6 in the global IP address “AAA.AAA.AAA.1” and forwards the generated packet to the router A.

[S26] The router A sends the packet P6c to the remote router R1, which then decapsulates the packet P6c and forwards the decapsulated packet to the terminal 51.

As described above, according to the present invention, when an IPsec tunnel is set up between the center router and the remote router which is assigned a non-fixed IP address, an ISAKMP default route is dynamically registered in addition to an ordinary IP default route. Thus, connection can be established along the route: local network under the remote router-Internet-intranet-gateway-Internet. It is therefore possible to configure a complex system and to perform high-quality routing on the network.

In the communication system of the present invention, the IPsec tunneling control section sets up an IPsec tunnel on the Internet. In the routing registration section, local IP addresses as destination addresses are statically registered and also the second router connected to the intranet is statically registered as a default route for addresses other than the registered local IP addresses. Also, when the IPsec tunnel is set up, the routing registration section identifies the global IP address of the remote router and dynamically registers the global IP address in association with the corresponding local IP address. The packet transfer section transfers packets in accordance with the routing table. Thus, even in the network environment in which an intranet and a local network are interconnected via the Internet by making use of IPsec and communication with the Internet is permitted only via a gateway server, high-quality routing can be performed without the need for complicated settings as those required in policy routing, thereby improving the convenience of network management and the operability.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A communication system for communicating packets, comprising:
a first router connected to the Internet;
a second router connected to an intranet;
a remote router located at a boundary between the Internet and a local network, the remote router being assigned a non-fixed IP address when connecting to the Internet for communication therewith; and
a center router connected to the first and second routers and located at a boundary between the Internet and the intranet, the center router including an IPsec tunneling control section for setting up an IPsec tunnel on the Internet between the center router and the remote router by using an ISAKMP default route indicative of routing to the first router, a routing registration section having a routing table in which local IP addresses as destination addresses are statically registered and in which the second router is statically registered as an IP default route for addresses other than the registered local IP addresses, the routing registration section identifying a global IP address of the remote router and dynamically registering the global IP address in the routing table in association with the corresponding local IP address when the IPsec tunnel is set up, and a packet transfer section for transferring packets in accordance with the routing table.

2. The communication system according to claim 1, wherein the communication system for communicating packets is configured in a network environment in which a gateway server having a firewall mechanism is located at a boundary between the intranet and the Internet, in which the intranet and the local network are interconnected through the IPsec tunnel set up on the Internet and in which communication with the Internet is permitted only via the gateway server.

3. The communication system according to claim 2, wherein, before the IPsec tunnel is set up, the packet transfer section discards a sending packet if the destination address of the sending packet coincides with any of the registered local IP addresses, and forwards the sending packet to the second router as the IP default route if the destination address of the sending packet does not coincide with any of the registered local IP addresses, and after the IPsec tunnel is set up, the packet transfer section forwards a sending packet to the second router as the IP default route if the destination address of the sending packet does not coincide with any of the registered local IP addresses, and forwards the sending packet to the first router by encapsulating the packet in the global IP address associated with the corresponding local IP address if the destination address of the sending packet coincides with any of the registered local IP addresses.

4. The communication system according to claim 3, wherein, during communication between a terminal under the remote router and the Internet in an Internet VPN communication environment, when a packet destined for the Internet is received from the terminal, the packet transfer section forwards the received packet to the second router as the IP default route in accordance with the routing table, and when a reply packet destined for the terminal is received from the Internet, the packet transfer section determines based on the routing table whether or not the destination address of the reply packet coincides with any of the registered local IP addresses and, if the destination address coincides with any of the registered local IP addresses, forwards the reply packet to the first router by encapsulating the packet in the global IP address associated with the corresponding local IP address.

5. The communication system according to claim 1, wherein, when the IPsec tunnel shuts down, the routing registration section deletes the global IP address registered in association with the corresponding local IP address.

6. A router device located at a boundary between the Internet and an intranet, connected to a first router connected to the Internet, and connected to a second router connected to the intranet, for routing packets, the router device comprising:
an IPsec tunneling control section for setting up an IPsec tunnel on the Internet between the router device and a remote router which is located at a boundary between the Internet and a local network and which is assigned a non-fixed IP address when connecting to the Internet for communication therewith, by using an ISAKMP default route indicative of routing to the first router;
a routing registration section having a routing table in which local IP addresses as destination addresses are statically registered and in which the second router is statically registered as an IP default route for addresses other than the registered local IP addresses, the routing registration section identifying a global IP address of the remote router and dynamically registering the global IP address in the routing table in association with the corresponding local IP address when the IPsec tunnel is set up; and
a packet transfer section for transferring packets in accordance with the routing table.

7. The router device according to claim 6, wherein the router device for routing packets is used in a network environment in which a gateway server having a firewall mechanism is located at a boundary between the intranet and the Internet, in which the intranet and the local network are interconnected through the IPsec tunnel set up on the Internet and in which communication with the Internet is permitted only via the gateway server.

8. The router device according to claim 7, wherein, before the IPsec tunnel is set up, the packet transfer section discards a sending packet if the destination address of the sending packet coincides with any of the registered local IP addresses, and forwards the sending packet to the second router as the IP default route if the destination address of the sending packet does not coincide with any of the registered local IP addresses, and after the IPsec tunnel is set up, the packet transfer section forwards a sending packet to the second router as the IP default route if the destination address of the sending packet does not coincide with any of the registered local IP addresses, and forwards the sending packet to the first router by encapsulating the packet in the global IP address associated with the corresponding local IP address if the destination address of the sending packet coincides with any of the registered local IP addresses.

9. The router device according to claim 8, wherein, during communication between a terminal under the remote router and the Internet in an Internet VPN communication environment, when a packet destined for the Internet is received from the terminal, the packet transfer section forwards the received packet to the second router as the IP default route in accordance with the routing table, and when a reply packet destined for the terminal is received from the Internet, the packet transfer section determines based on the routing table whether or not the destination address of the reply packet coincides with any of the registered local IP addresses and, if the destination address coincides with any of the registered local IP addresses, forwards the reply packet to the first router by encapsulating the packet in the global IP address associated with the corresponding local IP address.

10. The router device according to claim 6, wherein, when the IPsec tunnel shuts down, the routing registration section deletes the global IP address registered in associated with the corresponding local IP address.

11. A router device for routing packets, comprising:
an IPsec tunneling control section for setting up an IPsec tunnel on the Internet between the router device and a remote router which is assigned a non-fixed IP address when connecting to the Internet for communication therewith;
a routing registration section having two functions of statically and dynamically registering routes in a routing table thereof, the routing registration section identifying a global IP address of the remote router and dynamically registering the global IP address in the routing table in association with a corresponding local IP address when the IPsec tunnel is set up, and deleting the global IP address registered in association with the corresponding local IP address when the IPsec tunnel shuts down; and
a packet transfer section for transferring packets in accordance with the routing table.

12. A routing method for a router device which is located at a boundary between the Internet and an intranet, which is connected to a first router connected to the Internet and which is connected to a second router connected to the intranet, for routing packets, the routing method comprising the steps of:
arranging the router device in a network environment in which a gateway server having a firewall mechanism is located at a boundary between the intranet and the Internet, in which the intranet and a local network are interconnected through an IPsec tunnel set up on the Internet and in which communication with the Internet is permitted only via the gateway server;
setting up an IPsec tunnel on the Internet between the router device and a remote router which is located at a boundary between the Internet and the local network and which is assigned a non-fixed IP address when connecting to the Internet for communication therewith, by using an ISAKMP default route indicative of routing to the first router;
statically registering local IP addresses as destination addresses, statically registering the second router as an IP default route for addresses other than the registered local IP addresses, and identifying, when the IPsec tunnel is set up, a global IP address of the remote router and dynamically registering the global IP address in association with the corresponding local IP address;
discarding a sending packet if the destination address of the sending packet coincides with any of the registered local IP addresses before the IPsec tunnel is set up;
forwarding a sending packet to the second router as the IP default route if the destination address of the sending packet does not coincide with any of the registered local IP addresses before the IPsec tunnel is set up;
forwarding a sending packet to the second router as the IP default route if the destination address of the sending packet does not coincide with any of the registered local IP addresses after the IPsec tunnel is set up; and
forwarding a sending packet to the first router by encapsulating the packet in the global IP address associated with the corresponding local IP address if the destination address of the sending packet coincides with any of the registered local IP addresses after the IPsec tunnel is set up.

13. The routing method according to claim 12, wherein, during communication between a terminal under the remote router and the Internet in an Internet VPN communication environment, when a packet destined for the Internet is received from the terminal, the received packet is forwarded to the second router as the IP default route in accordance with a routing table, and when a reply packet destined for the terminal is received from the Internet, it is determined based on the routing table whether or not the destination address of the reply packet coincides with any of the registered local IP addresses, and if the destination address coincides with any of the registered local IP addresses, the reply packet is encapsulated in the global IP address associated with the corresponding local IP address and forwarded to the first router.
